(19) United States
(12) Patent Application Publication
(10) Pub. No.: US 2017/0342752 A1
(43) Pub. Date: Nov. 30, 2017

(54) Door Latch

(71) Applicant: Andrew P. Quam, McIntosh, MN (US)

(72) Inventor: Andrew P. Quam, McIntosh, MN (US)

(21) Appl. No.: 15/166,996

(22) Filed: May 27, 2016

(51) Int. Cl. E05C 19/18; E05C 19/10

(52) U.S. Cl. CPC E05C 19/184; E05C 19/10

(57) ABSTRACT

A door latch for securing a door in a closed position. The door latch generally includes a vise-grip comprising a clamp pliers having first and second jaws and a securing stay that is attachable to a non-door surface coupled to the first jaw. The second jaw comprises a first bushing coupled to the second jaw through which a rod is configured to pass. The rod comprises a first end configured to seat within a channel of a door and a second threaded end configured to threadably couple to an adjustment knob and apply pressure to at least one of an optional spring and second bushing when the door latch is engaged. The channel may be on a channel plate coupled to the door and may comprise a raised edge on the back surface to facilitate engaging a hook at the rod's first.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a door latch for securing a door in a closed position.

### Related Art

Any discussion of the related art throughout the specification should in no way be considered as an admission that such related art is widely known or forms part of common general knowledge in the field.

Conventional door latches which are commonly used in the agricultural and industrial arenas can be cumbersome to use and often create an obstruction in the doorway due to their position in the doorway when the door is in an open position. Such door latches are additionally obtrusive because they must be constructed of rigid materials capable of withstanding a great deal of force exerted upon them which may also increase the size of these devices making them clumsy for the user to manipulate and requiring that the user exert undue force on the latch in order to engage the latch to hold a door in a closed position. While these previously known devices for latching doors are suitable in certain circumstances, they are not suitable for easily closing and maintaining a door in a closed position while remaining unobtrusive and out of the doorway when the door is in an open position.

### SUMMARY

An example embodiment of the present invention is directed to a door latch. The door latch includes a vise-grip comprising a clamp pliers having a securing stay coupled to one jaw and a hook coupled to the second jaw via one or more bushing and an adjustment knob.

There has thus been outlined, rather broadly, some of the features of the door latch in order that the detailed description thereof may be better understood, and in order that the present contribution to the art may be better appreciated. There are additional features of the door latch that will be described hereinafter and that will form the subject matter of the claims appended hereto. In this respect, before explaining at least one embodiment of the door latch in detail, it is to be understood that the door latch is not limited in its application to the details of construction or to the arrangements of the components set forth in the following description or illustrated in the drawings. The door latch is capable of other embodiments and of being practiced and carried out in various ways. Also, it is to be understood that the phraseology and terminology employed herein are for the purpose of the description and should not be regarded as limiting.

Embodiments of a door latch may comprise a vise-grip comprising clamp pliers having first and second jaws and a securing stay coupled to the first jaw. A first bushing is coupled to the second jaw and a rod is configured to pass therethough. The rod comprises a first end that is configured to seat within a channel of a door and a second threaded end. In some embodiments, a second bushing may be coaxially located such that the rod passes from the first bushing through the second bushing which may optionally pass through a spring. The second threaded end of the rod is configured to threadably couple to an adjustment knob which applies a force to a securing plate and/or the second bushing and spring when the door latch is in use and tension is present across the hook and securing stay which is attached to a surface other than the door. The channel may be located in a channel plate that is secured to the door and to increase ease of engaging the hook within the channel, the channel plate may have a raised lip at least partially around the channel on the back surface of the channel plate. Some embodiments may further comprise a stop coupled to the rod between the first end and the second end or alternatively, may comprise at least one angular bend in the rod to prevent the rod from passing too far through the first bushing.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIGS. 1-2 provide perspective views of a door latch in use in accordance with an exemplary embodiment.

FIG. 3 is a perspective view of a door latch in accordance with an exemplary embodiment.

FIGS. 4-5 provide cross-sectional views of the door latch of FIG. 3 in a disengaged and engaged position, respectively.

FIGS. 6-8 provide top views of an exemplary embodiment a door latch with a securing stay coupled to an attachment surface throughout a process of securing a door.

FIG. 9 is a front perspective view of a channel plate in accordance with an exemplary embodiment.

FIG. 10 is a back perspective view of the channel plate in accordance with the embodiment of FIG. 9.

FIGS. 11-12 provide perspective and cross-sectional views of an alternative embodiment of a door latch.

### DETAILED DESCRIPTION

Unless otherwise defined, all technical and scientific terms used herein have the same meaning as commonly understood by one of ordinary skill in the art to which this invention belongs. Although methods and materials similar to or equivalent to those described herein can be used in the practice or testing of the door latch, suitable methods and materials are described above. All publications, patent applications, patents, and other references mentioned herein are incorporated by reference in their entirety to the extent allowed by applicable law and regulations. The door latch may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact. As used herein, phrases such as “make contact with,” “coupled to,” “touch,” “interface with” and “engage” may be used interchangeably.

The features, structures, or characteristics of the invention described throughout this specification may be combined in any suitable manner in one or more embodiments. For example, the usage of the phrases “exemplary embodiments”, “some embodiments” or other similar language refers to the fact that a particular feature, structure, or characteristic described in connection with the embodiment may be included in at least one embodiment of the present invention. Thus, appearances of the phrases “exemplary embodiments”, “in some embodiments”, “in other embodiments” or other similar language, throughout this specification do not necessarily all refer to the same group of embodiments, and the described features, structures, or characteristics may be combined in any suitable manner in one or more embodiments.

While the figures illustrate a sliding door, the various embodiments of the present invention may be used to secure various other types of doors. For example, the various embodiments of the door latch 10 may be used to secure a bi-fold door, a mono-fold door, a pivoting door and various other types of doors. While the various embodiments of the invention may be used with respect to various types of doors, the preferred door type is a sliding door type as illustrated in the drawings.

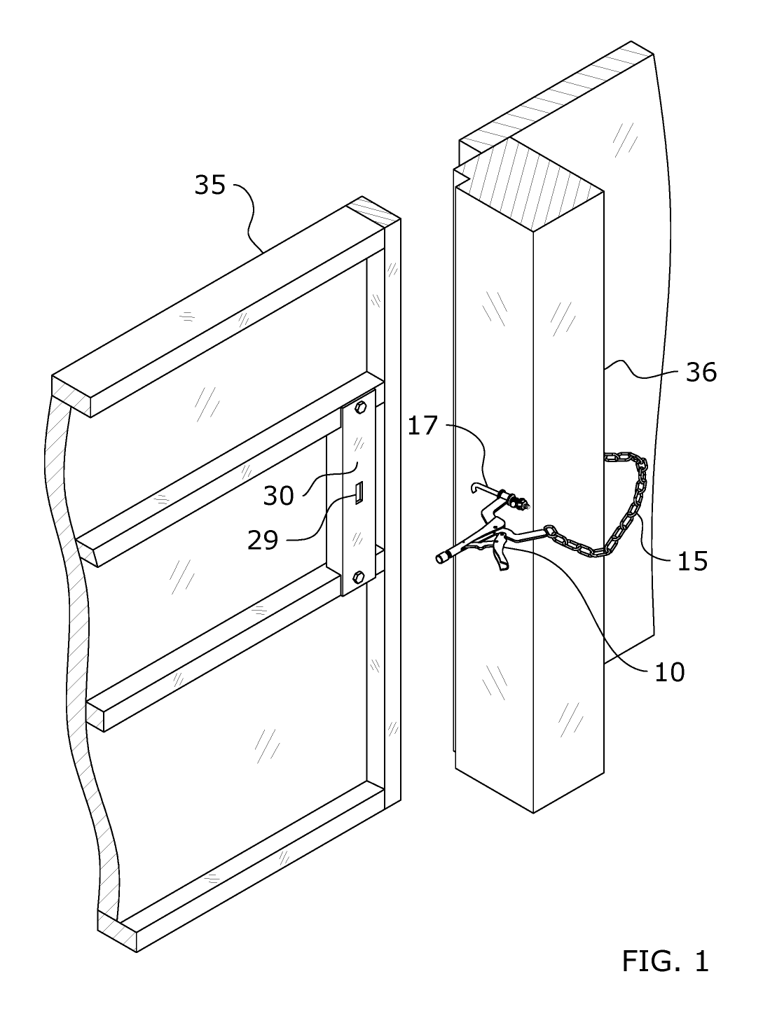

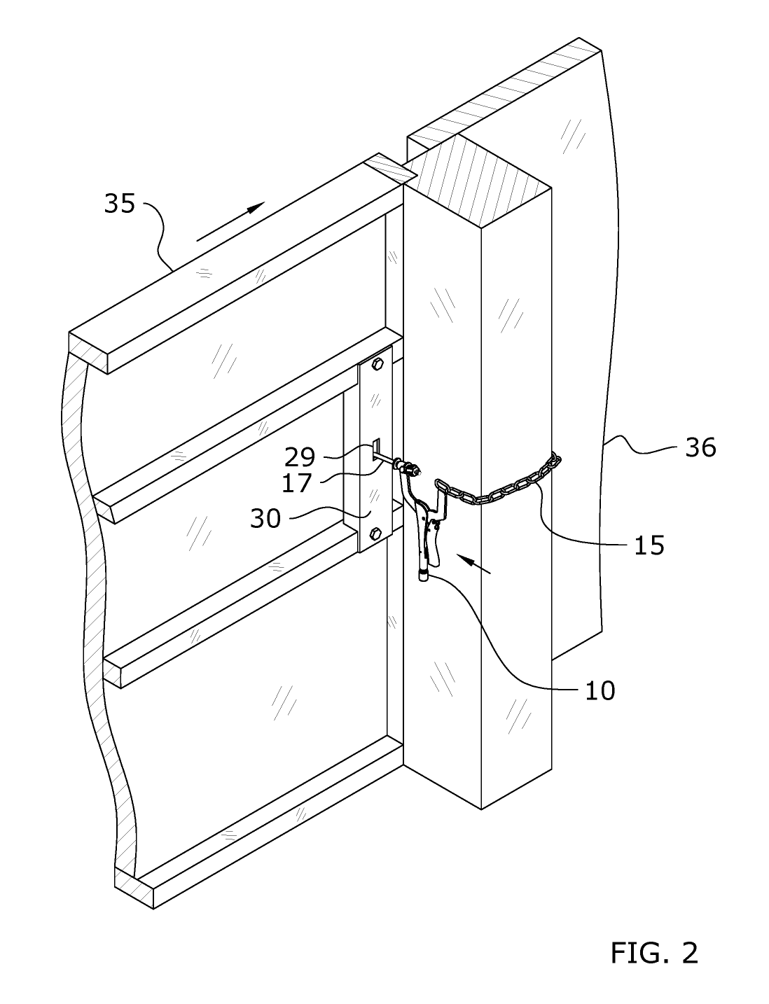

FIGS. 1-2 show an exemplary embodiment of a door latch 10 in use to secure a door 35. As shown, the door latch 10 comprises a securing stay 15 that may be attached to an attachment surface 36 at a location other than on the door 35 itself. In some embodiments, it may be preferable to attach the securing stay 15 to an attachment surface 36 that is on an opposite side of the door jamb as shown to keep the door latch 10 clear of the doorway when not in use, however, the securing stay 15 may be attached to any wall or other appropriate surface. When the door 35 is in a closed position as shown in FIG. 2, the rod 17 of the door latch 10 is inserted into a channel 29 of the door 35 and the latch 10 is engaged to hold the door 35 in the closed position. The channel 29 may be located directly on the surface of the door 35 or a channel plate 30 may be added to the door 35 to create an appropriately sized channel 29 at a height and distance from the door edge so as to facilitate ease in using the door latch 10.

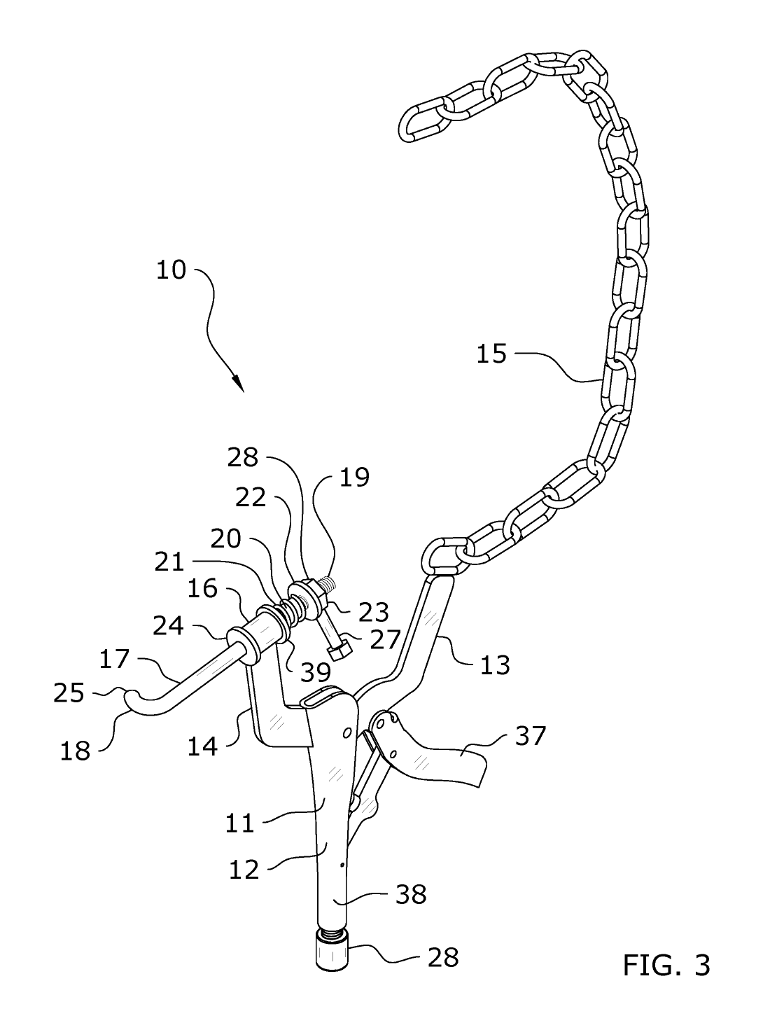

FIGS. 3-5 depict an exemplary embodiment of a door latch 10 comprising a modified vise-grip 11 that comprises a clamp pliers 12 having a first hand grip 37 and a second hand grip 38 that may be pressed or squeezed together to engage the first 13 and second jaws 14. The tension and positioning of the jaws 13, 14 may be adjusted by set screw 28 located at an end of the second hand grip 38. A securing stay 15 having a length sufficient to allow for coupling to an attachment surface 36 at a location other than on the door 35 itself is coupled to an end of the first jaw 13. The securing stay 15 is shown here as a chain, however, this disclosure is not intended to be limited as such and the securing stay 15 may also comprise a cable, strap, rope, or any other item or material of sufficient tensile strength and length to maintain a door 35 in a closed position when the door latch 10 is engaged. The securing stay 15 may be coupled to the first jaw 13 by welding or through the use of a fastener 40 to hold the securing stay in place on the first jaw 13. The length of the first 13 and second jaws 14 relative to one another may be the same or may be different depending upon the type of securing stay 15 used and the manner in which it is coupled to the first jaw 13.

The second jaw 14 may comprise a first bushing 16 that is coupled by welding or that may be integral to the second jaw 14. The first bushing 16 is sized appropriately to allow a rod 17 to pass therethrough. The rod 17 may comprise a first end 18 having a hook 25 or other appropriate shape so as to securely attach within a channel 29 located in the door 35 itself or in another device such as a channel plate 30 that may be attached to the door 35. In some embodiments, the rod 17 may comprise a stop 24 coupled to or integral with the rod 17 at a location along the rod 17 past which allowing the first end 18 of the rod 17 to pass through the first bushing 16 would be undesirable. The stop 24 may comprise a washer, ring, or plate which may be fixedly or removably coupled to the rod 17. The rod 17 further comprises a second threaded end 19 distal from the first end 18 of the rod 17 which is configured to threadably couple with an adjustment knob 23 that holds the rod 17 in place at a desired position. The adjustment knob 23 may comprise any device configured to threadably couple to the second threaded end 19 of the rod 17, however, in some embodiments, the adjustment knob 23 may comprise a bolt 27 welded to a nut 26. A second bushing 20 through which the rod 17 also passes may be located between the first bushing 16 and the adjustment knob 23 and a spring 21 of appropriate diameter to allow passage of the second bushing 20 therethough may also be present between the first bushing 16 and adjustment knob 23. The second bushing 20 may provide additional stability for the door latch 10 when in use in the event of a failure of the spring 21.

In some embodiments, the door latch 10 may further comprise a backing plate 39 located between the first 16 and second bushings 20. The backing plate 39 may be especially useful when the diameter of the first bushing 16 is larger than the diameter of the second bushing 20 so as to prevent the second bushing 20 and/or the spring 21 from passing into or through the first bushing 16. The backing plate 39 may comprise a washer, ring, or plate which may be welded or otherwise coupled to the first bushing 16, or alternatively, the backing plate 39 may be integral to the first bushing 16. Regardless, the backing plate 39 is comprised of a material having sufficient strength to withstand the force exerted upon it by the second bushing 20 and/or spring 21 when the adjustment knob 23 is secured and the first end 18 of the rod 17 is engaged within a channel 29 of the door 35. Additionally, some embodiments of the door latch 10 may comprise a securing plate 22 located between the second bushing 20 and/or spring 21 and the adjustment knob 23. The securing plate 22 may comprise a washer, ring, or plate which may be welded or otherwise coupled to the adjustment knob 23, or alternatively, the securing plate 22 may be integral to the adjustment knob 23. While the securing plate 22 may be omitted from some embodiments, when used, it may provide a stable surface to apply pressure to the spring 21 and/or second bushing 20 when the adjustment knob 23 is tightened to secure the door latch 10 when in use.

In accordance with the embodiment of FIGS. 3-5, to secure a door 35 using the door latch 10, the first end 18 of the rod 17 comprising a hook 25 is placed into a channel 29 located in a channel plate 30 that is coupled to the door 35 when the clamp pliers 12 are disengaged. The rod 17 then passes through the first bushing 18 until the stop 24 is in contact with the first bushing 16 as a result of the first 37 and second hand grips 38 being depressed so as to engage the clamp pliers 12. The adjustment knob 23 may then be used to increase pressure on the spring 21 and/or second bushing 20 while there is tension across the first 13 and second jaws 14 due to the hook 25 being engaged with the door channel 29 and the securing stay 15 being affixed to a non-door attachment surface 36 at a point at which the securing stay 15 is taut.

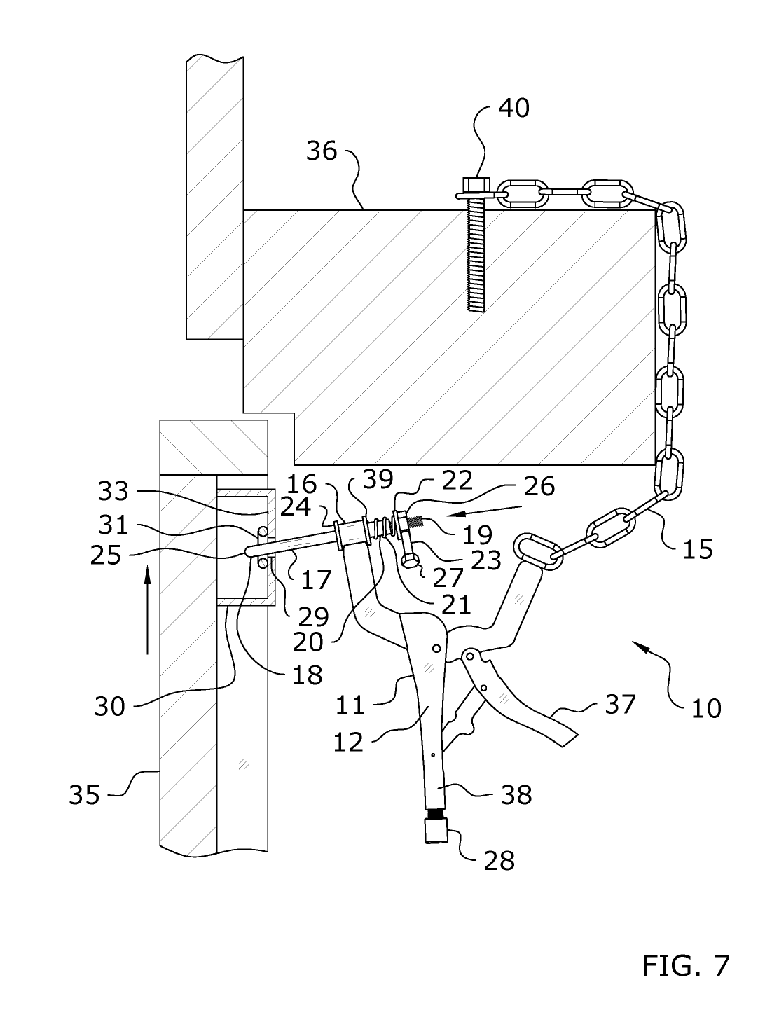

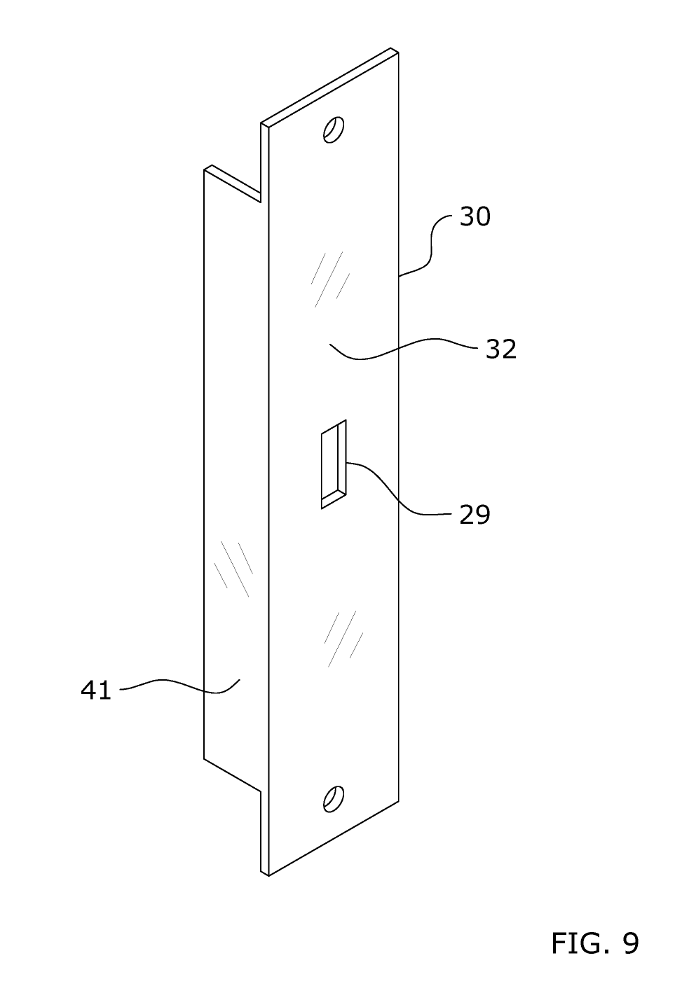

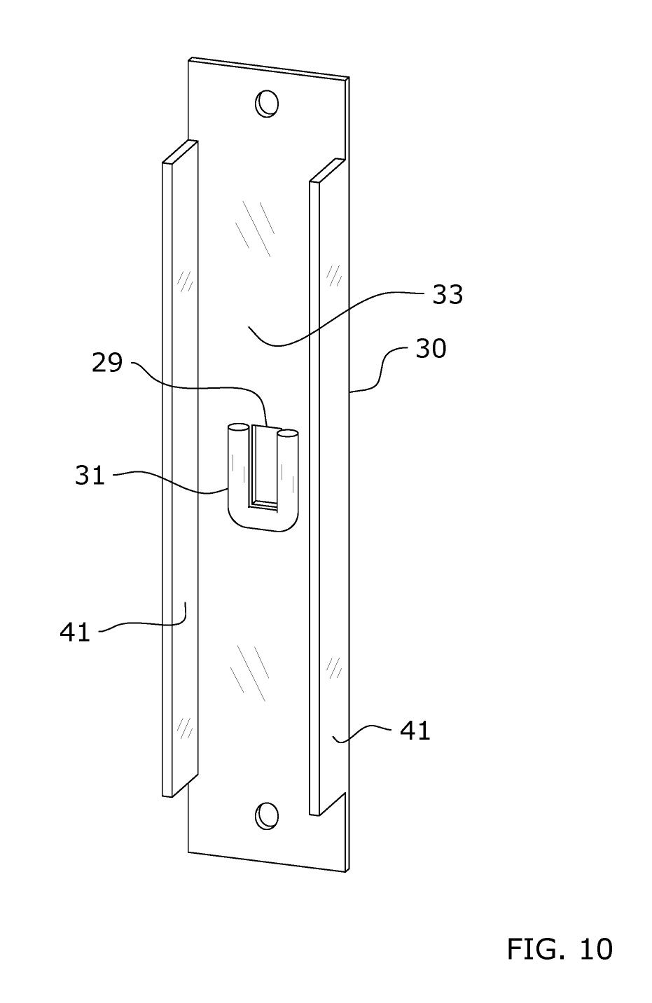

In some embodiments, a channel plate 30, such as the exemplary embodiment shown if FIGS. 9-10 may be coupled to the door 35 to create an appropriate channel 29 to engage the first end 18 of the rod 17 when the door latch 10 is in use. While the channel plate 30 may have any appropriate shape, many commonly used doors 35 can most easily accommodate a rectangular shaped channel plate 30 comprising one or more fastening holes therethrough and having one or more side walls 41 extending perpendicularly from the plate surface to maintain an appropriate distance between the back surface 33 of the channel plate 30 and a surface of the door 35. This configuration allows adequate space for the first end 18 of the rod 17 to be inserted into the channel 20 and pass from the front surface 32 of the channel plate 30 through the channel 29 and engage with a raised edge 31 that at least partially surrounds the perimeter of the channel 29 on the back surface 33 of the channel plate 30 as the rod 17 is passed through the channel 29 as shown in FIG. 7.

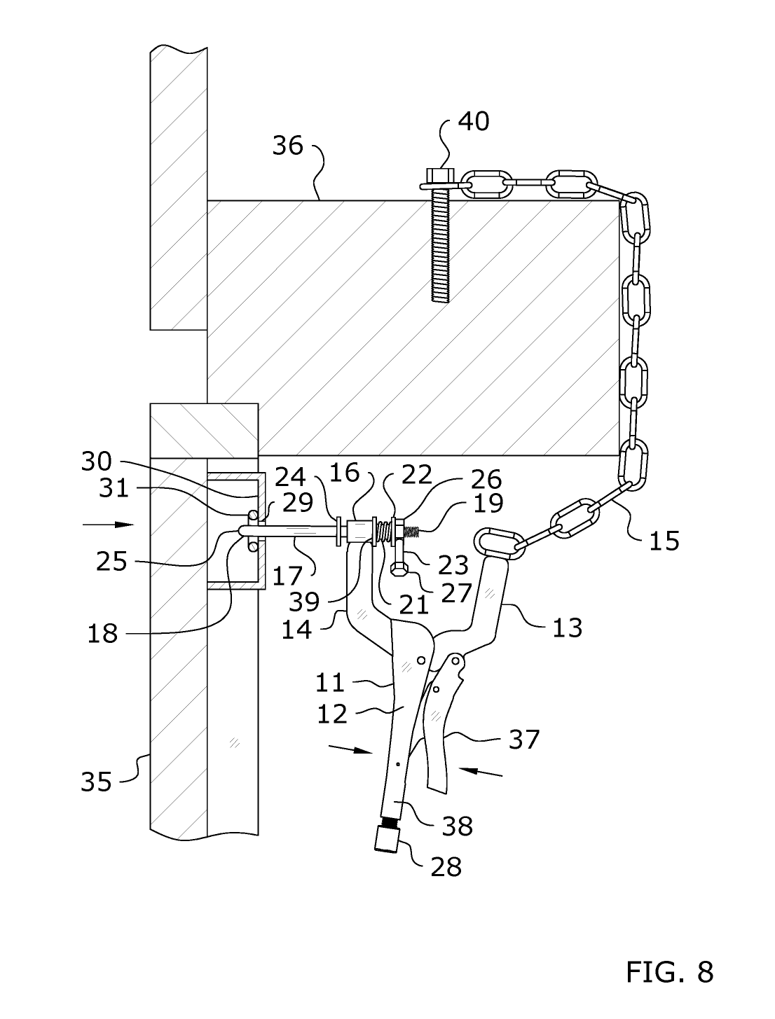

When the door 35 is moved to a closed position and the first 37 and second hand grips 38 are depressed as shown in FIG. 8, the hook 25 or other securing device at the first end 18 of the rod 17 engages with the raised edge 31 on the back surface 33 of the channel plate 30 and secures the door 35 in a closed position due to the tension between the hook 25 and the securing stay 15 which is shown here as being fastened to an opposite side of the door jamb. The raised edge 31 is depicted in FIG. 10 as having a U-shape that runs along the bottom and sides of the channel 29, however, other embodiments may comprise any other configuration having at least a portion of the perimeter of the channel 29 comprising a raised edge 31. In some embodiments, the raised edge 31 may be omitted and the hook 25 or other securing device on the first end 18 of the rod 17 may engage directly with the channel wall.

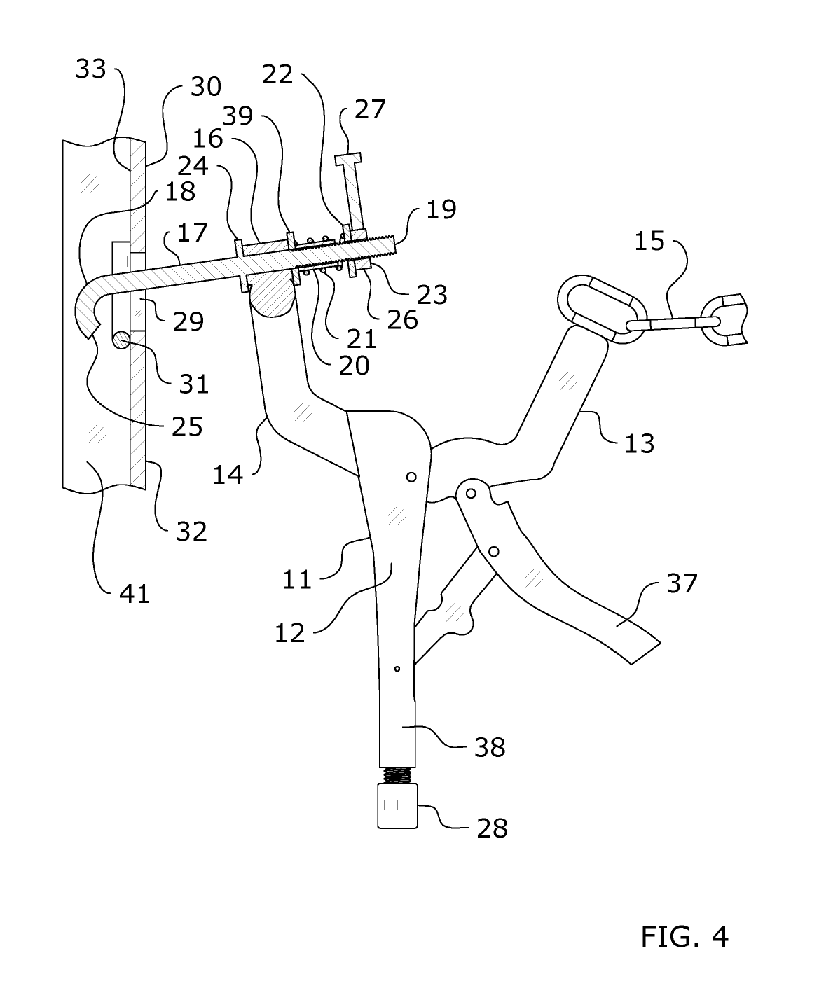

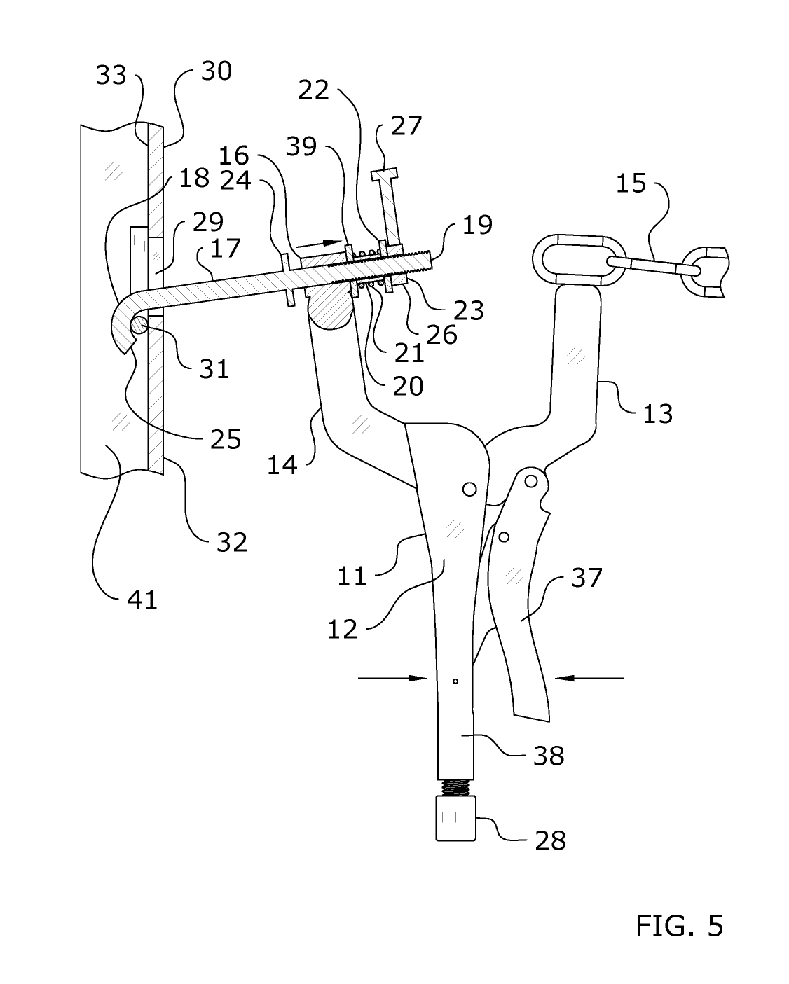

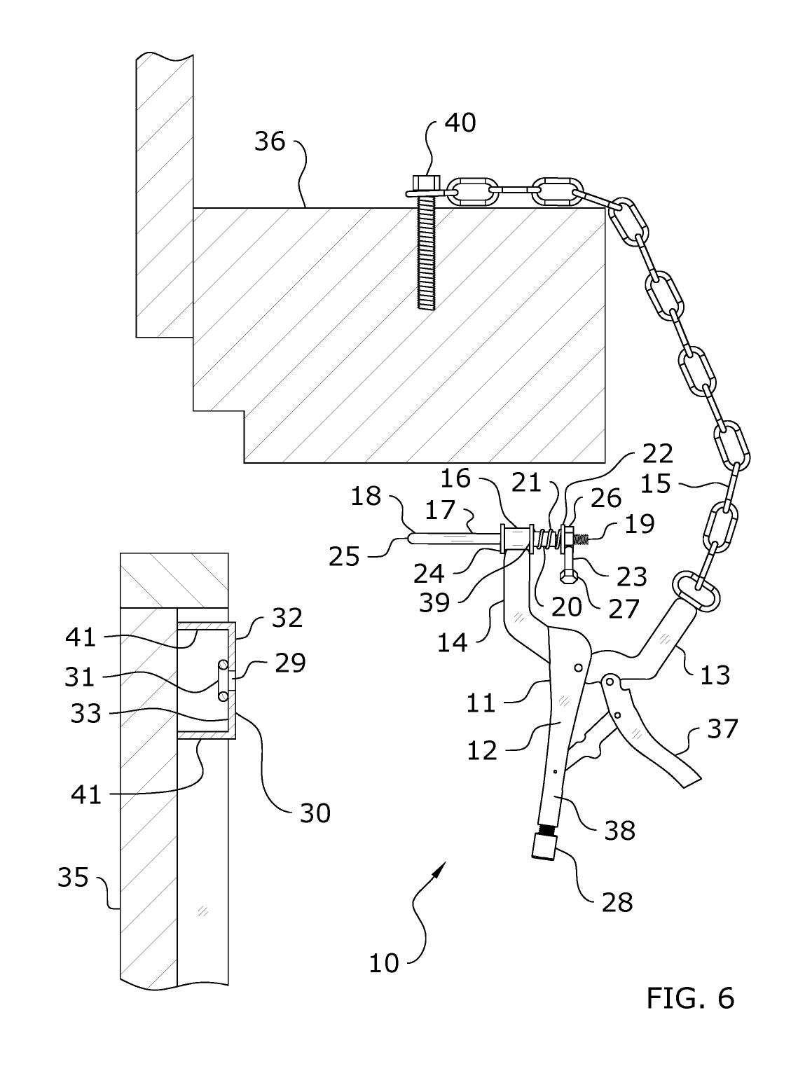

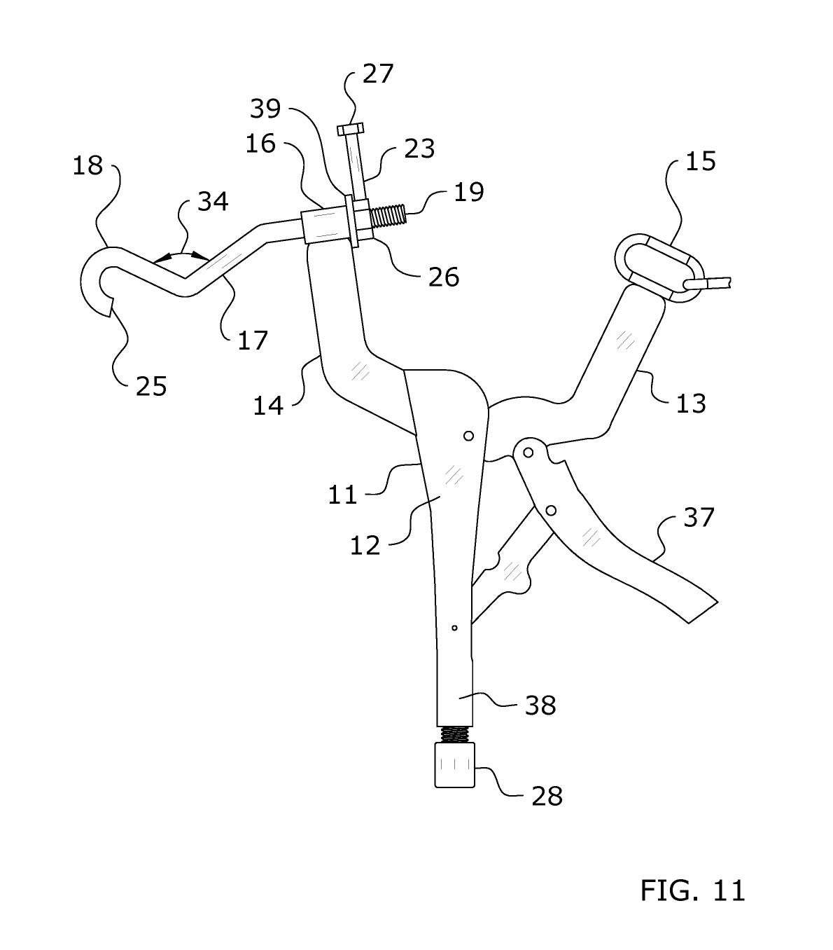

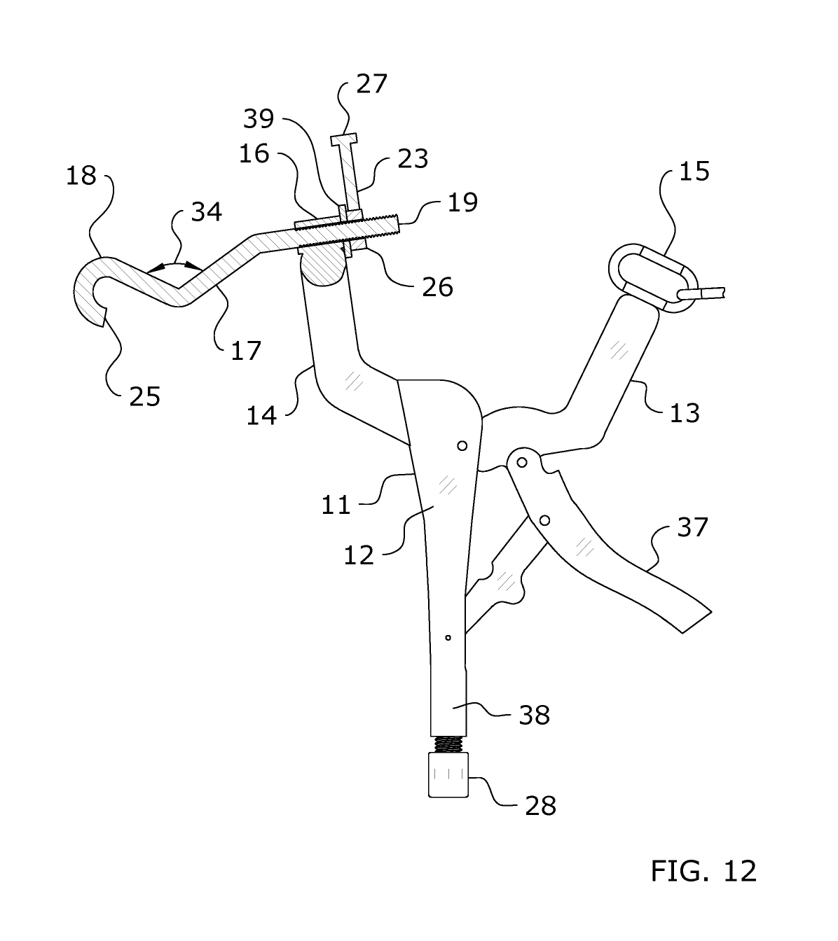

FIGS. 11-12 depict an alternative embodiment of a door latch 10 in which the rod 17 comprises at least one angular bend 34 at a location past which it is undesirable for the first end 18 of the rod 17 to pass further into the first bushing 16. This angular bend 34 flexes when tension is applied to the rod 17 thereby acting as a spring as the rod 17 attempts to enter into a substantially straight state (e.g. the angular bend 34 may replace the spring 21). The rod 17 is constructed of a resilient material (e.g. metal, steel) that does not break when the angular bend 34 increases in angle as the rod 17 is straightened out under tension. This angular bend 34 may also serve as a stop 24 to prevent the rod 17 from slipping entirely through the first bushing 16 when the door latch 10 is not in use and therefore, a separate stop 24 such as that depicted in FIGS. 4-5 is unnecessary and may be omitted. While the angular bend 34 may utilize any appropriate angle, it may be preferable in some embodiments that the angle of the bend be at least about 45 degrees. As shown, the adjustment knob 23 may threadably couple with the second threaded end 19 of the rod 17 without a second bushing 20 and spring 21 between the first bushing 16 and adjustment knob 23, however these components may also be present in this embodiment if desired.

It is to be understood that the embodiments and claims are not limited in application to the details of construction and arrangement of the components set forth in the description and/or illustrated in drawings. Rather, the description and/or the drawings provide examples of the embodiments envisioned, but the claims are not limited to any particular embodiment or a preferred embodiment disclosed and/or identified in the specification. Any drawing figures that may be provided are for illustrative purposes only, and merely provide practical examples of the invention disclosed herein. Therefore, any drawing figures provided should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations

What is claimed is:

1. A door latch comprising:
a vise-grip comprising a clamp pliers having a first jaw and a second jaw;
a securing stay coupled to the first jaw;
a first bushing coupled to the second jaw;
a rod configured to pass through the first bushing, the rod comprising:
a first end configured to seat within a channel of a door; and
a second threaded end;
a second bushing configured to pass over the rod proximal to the second threaded end of the rod;
a spring configured to pass over the second bushing;
a securing plate configured to pass over the rod proximal to an end of the spring that is distal from the first bushing; and
an adjustment knob configured to threadably couple to the second threaded end of the rod and apply pressure to at least one of the spring and the second bushing when the door latch is engaged.

2. The door latch of claim 1, wherein the rod further comprises a stop coupled to the rod between the first end and the second threaded end.

3. The door latch of claim 1, wherein the securing stay comprises at least one of a chain, a cable, or a strap.

4. The door latch of claim 1, wherein the first end of the rod comprises a hook.

5. The door latch of claim 1, wherein the securing plate comprises a washer.

6. The door latch of claim 1, wherein the adjustment knob comprises a nut having a bolt welded thereto.

7. The door latch of claim 1, wherein the clamp pliers further comprise a set screw configured to adjust a tension between the first and second jaws when the door latch is engaged.

8. The door latch of claim 1, further comprising a channel plate that forms the channel of the door when the channel plate is coupled to the door.

9. The door latch of claim 8, wherein the channel plate further comprises a raised edge at least partially surrounding the channel on a back surface of the channel plate.

10. A door latch comprising:
a vise-grip comprising a clamp pliers having a first jaw and a second jaw;
a securing stay coupled to the first jaw;
a first bushing coupled to the second jaw;
a rod configured to pass through the first bushing, the rod comprising:
a first end configured to seat within a channel of a door; and
a second threaded end; and
an adjustment knob configured to threadably couple to the second threaded end of the rod at a position along the second threaded end of the rod so as to prevent movement of the door when the door latch is engaged.

11. The door latch of claim 10, wherein the first end of the rod comprises a hook.

12. The door latch of claim 11, wherein the rod further comprises at least one angular bend along a length of the rod proximal to the first end of the rod and configured to prevent the rod from passing through the first bushing beyond the position of the at least one angular bend.

13. The door latch of claim 10, wherein the securing stay comprises at least one of a chain, a cable, or a strap.

14. The door latch of claim 10, wherein the adjustment knob comprises a nut having a bolt welded thereto.

15. The door latch of claim 10, further comprising a channel plate that forms the channel of the door when the channel plate is coupled to the door.

16. A method of securing a door using door latch comprising:
fastening a securing stay that is coupled to a first jaw of a clamp pliers of a vise-grip to a surface other than the door;
inserting a first end of a rod comprising a hook into a channel of the door, the rod passing through a first bushing coupled to a second jaw of the clamp pliers;
engaging the clamp pliers such that a tension is applied across the securing stay and the hook when the door is in a closed position; and
threadably engaging an adjustment knob with a second threaded end of the rod on a side of the first bushing that is distal from the first end of the rod such that movement of the door is prevented when the door latch is engaged.

17. The method of claim 16, wherein the securing stay comprises at least one of a chain, a cable, and a strap, and the method further comprises fastening the securing stay on the surface other than the door at a length at which the door is prevented from moving when the door latch is engaged.

18. The method of claim 16, further comprising adjusting a set screw in a handle of the clamp pliers to adjust the tension across the securing stay and the hook.

19. The method of claim 16, further comprising threadably engaging the adjustment knob with the second threaded end of the rod until the adjustment knob applies a pressure to at least one of a second bushing through which the rod passes, a spring through which the second bushing passes, and a securing plate through which the rod passes.

20. The method of claim 16, wherein the channel of the door is located on a channel plate coupled to the door and the method further comprises engaging the hook with a raised edge at least partially surrounding the channel on a back surface of the channel plate.
